(19) United States
(12) Patent Application Publication
(10) Pub. No.: US 2024/0152001 A1
(43) Pub. Date: May 9, 2024

(54) METHODS AND SYSTEMS FOR MANAGING ELECTRICAL CONNECTIONS DURING ASSEMBLY OF GLASS ARTICLES WITH DISPLAYS

(71) Applicant: Corning Incorporated, Corning, NY (US)

(72) Inventors: Tomohiro Ishikawa, Corning, NY (US); Christopher Lee Timmons, Big Flats, NY (US)

(21) Appl. No.: 18/283,045

(22) PCT Filed: Mar. 21, 2022
(86) PCT No.: PCT/US2022/021127

§ 371 Date: Sep. 20, 2023

Related U.S. Application Data
(60) Provisional application No. 63/166,579, filed on Mar. 26, 2021.

(51) Int. Cl. G02F 1/1333; B60K 35/22; G02F 1/13

(52) U.S. Cl. CPC G02F 1/133354; G02F 1/1303; B60K 35/22; B60K 2360/96

(57) ABSTRACT

Embodiments of the disclosure relate to a method of assembling a glass article. The glass article includes a display module and a glass sheet. In the method, an electronic ribbon connector is positioned in a vertical position. The electronic ribbon connector has a first end connected to the display module and a second free end. The display module is attached to the glass sheet. Adhesive is applied to the glass sheet around the display module. A frame is arranged over the glass sheet. The frame has a depending edge and a slot positioned adjacent to the depending edge. The frame is moved towards the glass sheet such that the second free end of the electronic ribbon connector extends through the slot and such that the depending edge of the frame contacts the adhesive.

### CROSS-REFERENCE TO RELATED APPLICATIONS

This application claims the benefit of priority under 35 U.S.C. § 119 of U.S. Provisional Application Ser. No. 63/166,579 filed on Mar. 26, 2021 the content of which is relied upon and incorporated herein by reference in its entirety.

### BACKGROUND

The disclosure relates to systems and methods for assembling glass articles having display modules and, more particularly, to systems and methods for managing electronic ribbon connectors of the display modules during assembly of the glass articles.

Vehicle interiors often include displays, and in order to integrate the displays into the aesthetic of the vehicle interior, such displays may be incorporated into curved and decorative surfaces of the vehicle. The materials used to form display surfaces are typically limited to polymers, which do not exhibit the durability and optical performance of glass. As such, glass sheets are desirable, especially when used as covers for displays. Existing methods of forming such glass articles involve bonding a glass sheet to a frame in a forming operation. To further incorporate a display module, consideration must be made during the assembly process for making electrical connections to the display module. In this regard, management of wires, cables, connectors, and connector ribbons can decrease the efficiency of the assembly process and impedes conversion to an automated process.

### SUMMARY

According to an aspect, embodiments of the disclosure relate to a method of assembling a glass article. The glass article includes a display module and a glass sheet. The glass sheet has a first major surface and a second major surface opposite to the first major surface. In the method, an electronic ribbon connector is positioned in a vertical position transverse to the second major surface of the glass sheet. The electronic ribbon connector has a first end connected to the display module and a second free end. The display module is attached to the second major surface of the glass sheet. Adhesive is applied to the second major surface of the glass sheet around the display module. A frame is arranged over the second major surface of the glass sheet. The frame has a depending edge and a slot positioned adjacent to the depending edge. The frame is moved towards the second major surface of the glass sheet such that the second free end of the electronic ribbon connector extends through the slot and such that the depending edge of the frame contacts the adhesive.

According to another aspect, embodiments of the disclosure relate to a system for assembling a glass article. The glass article includes a glass sheet having a first major surface and a second major surface opposite to the first major surface. A display module that includes an electronic ribbon connector is attached to the second major surface of the glass sheet. A frame that includes a slot is attached to the second major surface. The system includes a chuck having a forming surface defining a curvature. The glass sheet is configured to be bent into conformity with the forming surface. The system also includes a dispenser nozzle configured to apply adhesive to the second major surface of the glass sheet around the display module. Further, the system includes at least one manipulator configured to move the electronic ribbon connector to a vertical position such that the frame is able to be lowered into contact with the adhesive and such that an end of the electronic ribbon connector is inserted through the slot in the frame.

According to still another aspect, embodiments of the disclosure relate to a method of assembling a glass article. The glass article includes a display module and a glass sheet having a first major surface and a second major surface opposite to the first major surface. The display module is attached to the second major surface of the glass sheet, and the display module includes a connector socket arranged transversely to the second major surface. In the method, adhesive is applied to the second major surface of the glass sheet around the display module. A frame is arranged over the second major surface of the glass sheet. The frame has a depending edge and a slot positioned adjacent to the depending edge. The frame is moved towards the second major surface of the glass sheet such that the slot is positioned over the connector socket of the display module and the depending edge of the frame contacts the adhesive. A first end of an electronic ribbon connector is inserted through the slot, and the first end of the electronic ribbon connector is plugged into the connector socket.

According to yet another aspect, embodiments of the disclosure relate to a glass article. The glass article includes a glass sheet having a first major surface and a second major surface. The second major surface is opposite to the first major surface. A display module is attached to the second major surface of the glass sheet. The display module includes an electronic ribbon connector. Further, the glass article includes a unitary frame having a substrate, a depending edge, and a slot. The slot extends through the substrate and is positioned adjacent the depending edge. A backlight unit is mounted on a first side of the unitary frame facing the display module. The depending edge of the unitary frame is adhered to the second major surface of the glass sheet. A gap is provided between the display module and the backlight unit. Further, the electronic ribbon connector extends from the display module through the slot in the unitary frame to a second side of the unitary frame opposite to the first side.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. In the drawings:

FIG. 1 is a perspective view of a vehicle interior with vehicle interior systems, according to exemplary embodiments;

FIGS. 2A-2C depict a method of assembling a glass article including a display module and frame attached to a glass sheet, respectively, according to exemplary embodiments;

FIG. 3 depicts a detail view of an end of a glass article, according to an exemplary embodiment;

FIG. 4 schematically depicts a method of assembling the glass article using two manipulators to position an electronic ribbon connector, according to an exemplary embodiment;

FIG. 5 schematically depicts a method of assembling the glass article using an articulated manipulator to position an electronic ribbon connector, according to an exemplary embodiment;

FIGS. 6A-6C depict a rotary manipulator used to position an electronic ribbon connector during assembly of a glass article, according to an exemplary embodiment;

FIGS. 7A and 7B depict sensors used to determine that an electronic ribbon connector has been placed in a vertical position, according to an exemplary embodiment;

FIGS. 8A-8C depict three embodiments related to positioning the electronic ribbon connector in a vertical position prior to assembly and without the use of manipulators, according to an exemplary embodiment;

FIG. 9 depicts a display module having a connector socket instead of an electronic ribbon connector, which avoids the need to manage the electronic ribbon connector during assembly, according to an exemplary embodiment; and

FIG. 10 depicts geometric dimensions of a glass sheet, according to an exemplary embodiment.

### DETAILED DESCRIPTION

Reference will now be made in detail to various embodiments of methods and systems for assembling a glass article including a display module, examples of which are illustrated in the accompanying drawings. As will be described in greater detail below, a glass article according to the present disclosure includes a glass sheet having one or more display modules attached thereto. In embodiments, the glass sheet of the glass article is cold-formed from a planar configuration to define a curvature, and a frame holds the glass sheet in the curved, cold-formed configuration. By “cold-formed,” it is meant that the glass sheet is shaped elastically at a temperature below the softening point of the glass. Absent the frame to hold the glass sheet in the curved, cold-formed configuration, the glass sheet would elastically revert to the planar configuration. In embodiments, the display module is also cold-formed over the glass sheet or cold-formed with the glass sheet, which precludes the use of bulky, inflexible displays having a display module integral with a backlight unit. Designs in which the display module is decoupled from the backlight unit are referred to as “open-cell” designs, and the separation of the display module from the backlight means that electrical connections need to be routed from the display module to the backlight unit and any control circuitry. As will be discussed more fully below, conventional methods to manage such electrical connections during assembly are inefficient, labor-intensive, and impede automation. According the present disclosure, methods and systems are provided to position the electrical connections for inserting through a slot in the frame in an automated manner, enhancing the efficiency of the assembly process. These and other aspects and advantages will be described more fully in relation to the exemplary embodiments provided below and in the drawings. These embodiments are presented by way illustration and not limitation.

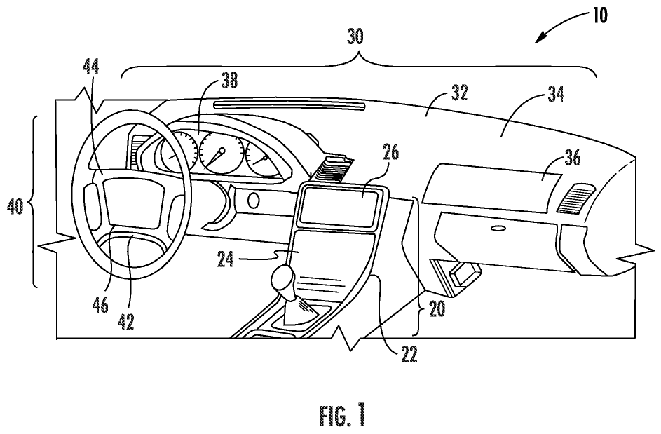

In order to provide context for the following discussion, exemplary embodiments of glass articles will be described in relation to the particular application of a vehicle interior system. FIG. 1 shows an exemplary interior 10 of a vehicle that includes three different embodiments of vehicle interior systems 20, 30, 40. Vehicle interior system 20 includes a base, shown as center console base 22, with a surface 24 including a display 26. Vehicle interior system 30 includes a base, shown as dashboard base 32, with a surface 34 including a display 36. The dashboard base 32 typically includes an instrument panel 38 which may also include a display. Vehicle interior system 40 includes a base, shown as steering wheel base 42, with a surface 44 and a display 46. In one or more embodiments, the vehicle interior system includes a base that is an arm rest, a pillar, a seat back, a floor board, a headrest, a door panel, or any portion of the interior of a vehicle that includes a surface that includes a display. In embodiments, such surfaces are curved or planar.

The embodiments of the glass articles described herein can be used in each of vehicle interior systems 20, 30, 40, among others. In some such embodiments, the glass article discussed herein may include a cover glass sheet that also covers non-display surfaces of the dashboard, center console, steering wheel, door panel, etc. In such embodiments, the glass material may be selected based on its weight, aesthetic appearance, etc. and may be provided with a coating (e.g., an ink or pigment coating) including a pattern (e.g., a brushed metal appearance, a wood grain appearance, a leather appearance, a colored appearance, etc.) to visually match the glass components with adjacent non-glass components. In specific embodiments, such ink or pigment coating may have a transparency level that provides for deadfront or color matching functionality when the display 26, 36, 38, 46 is inactive. Further, while the vehicle interior of FIG. 1 depicts a vehicle in the form of an automobile (e.g., cars, trucks, buses and the like), the glass articles disclosed herein can be incorporated into other vehicles, such as trains, sea craft (boats, ships, submarines, and the like), aircraft (e.g., drones, airplanes, jets, helicopters and the like), and spacecraft.

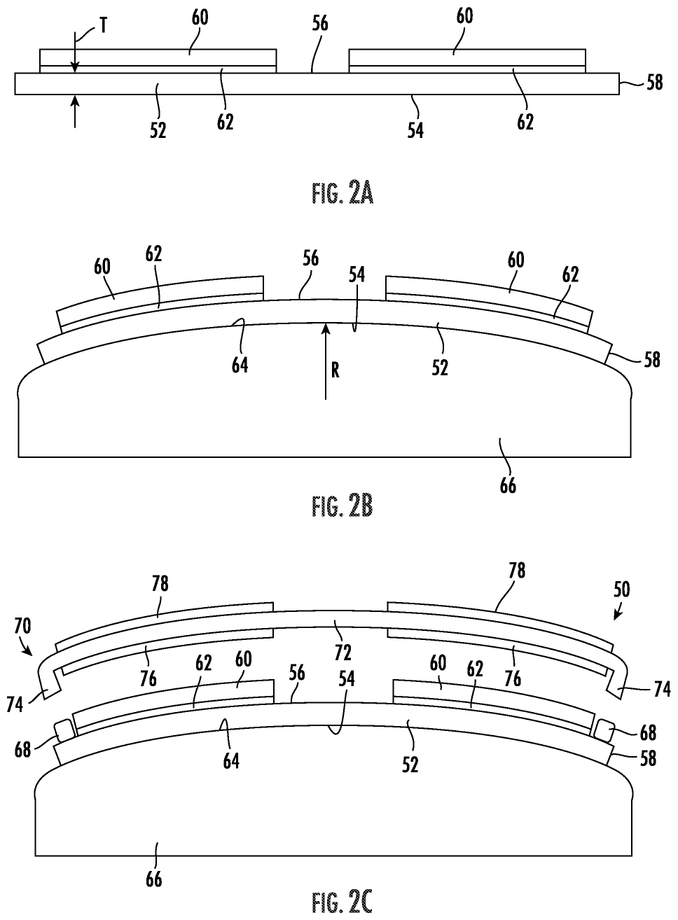

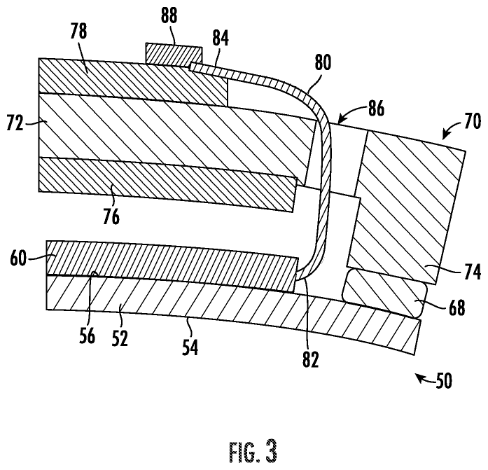

In embodiments, the surfaces 24, 34, 44 can be flat or planar (i.e., having a radius of curvature of 10 m or more), or in embodiments, the surfaces 24, 34, 44 be any of a variety of curved shapes or shapes with both curved regions and flat regions, such as V-shaped (curved region between two flat regions) or C-shaped (substantially continuously curved), amongst others. FIGS. 2A-2C depict an exemplary method of assembling a glass article 50. The glass article 50 includes a glass sheet 52 having a first major surface 54, a second major surface 56 opposite to the first major surface 54, and a minor surface 58 joining the first major surface 54 to the second major surface 56. The first major surface 54 and the second major surface 56 define a thickness T of the glass sheet 52. In embodiments, the thickness T of the glass sheet 52 is from 0.3 mm to 2 mm, in particular 0.5 mm to 1.1 mm. In a vehicle, the first major surface 54 faces the occupants of the vehicle.

In embodiments, the first major surface 54 and/or the second major surface 56 includes one or more surface treatments. Examples of surface treatments that may be applied to one or both of the first major surface 54 and second major surface 56 include an anti-glare coating, an anti-reflective coating, a coating providing touch functionality, a decorative (e.g., ink or pigment) coating, and an easy-to-clean coating.

The glass article 50 also includes one or more display modules 60 that are attached to the second major surface 56 of the glass sheet 52. In embodiments, the display modules 60 are attached to the second major surface 56 using an optically clear adhesive 62. As can be seen in FIG. 2A, the glass sheet 52 is in a planar configuration when the display modules 60 are attached to the second major surface 56. Embodiments of the present disclosure relate to glass articles 50 having an open-cell design, and thus, the display modules 60 utilized in embodiments of the present disclosure are those that require a backlight unit, such as liquid crystal display (LCD) modules.

With reference now to FIG. 2B, the glass sheet 52 having the display modules 60 attached thereto is bent to a curved configuration over a forming surface 64 of a chuck 66. The forming surface 64 defines a first radius of curvature R. In embodiments, the first radius of curvature R is from 50 mm up to less than planar (e.g., less than 10 m). Upon bending the glass sheet 52 into a curved configuration on the chuck 66, the glass sheet 52 may be held in the curved configuration against the forming surface using a variety of suitable forces, such as mechanical retainers, vacuum pressure between the first major surface 54 and the forming surface 64, self-adhesive material, or a combination thereof. In the curved configuration, the glass sheet 52 defines a second radius of curvature that is within 10%, or within 5%, or within 2% of the first radius of curvature R.

While FIGS. 2A and 2B depict the display modules 60 being attached to the glass sheet 52 in the planar configuration, the display modules 60, in embodiments, could be attached to the glass sheet 52 in the curved configuration. For example, the glass sheet 52 can be bent over the forming surface 64 of the chuck 66 before the display modules 60 are attached to the glass sheet 52. In this way, the glass sheet 52 is cold-formed first, and the display modules 60 are then cold-formed over the glass sheet 52.

As shown in FIG. 2C, an adhesive 68 is applied to the second major surface 56 of the glass sheet 52. In embodiments, the adhesive 68 is applied in a bead around the perimeter of the glass sheet 52. In embodiments, the adhesive 68 is a structural adhesive, such as toughened epoxy, flexible epoxy, acrylics, silicones, urethanes, polyurethanes, or silane modified polymers.

The glass article 50 also includes a frame 70. The frame 70 is configured to hold the glass sheet 52 in the curved configuration after the glass article 50 is removed from the chuck 66. The frame 70 includes a substrate 72 from which a depending edge 74 extends. In embodiments, the substrate 72 is a substantially continuous panel, and in other embodiments, the substrate 72 contains cutouts into which other panels may be inserted (e.g., to mount a backlight unit as discussed below). The depending edge 74 may extend from the substrate 72 continuously or discontinuously around the perimeter of the substrate 72 or around a portion thereof. In embodiments, a rear portion of the glass article 50 (i.e., second major surface 56, display modules 60, and frame 70) may also be contained in a housing (not shown) to provide a dust barrier. Further, in embodiments, the substrate 72 and depending edge 74 are unitary, defining a single piece frame 70. In other embodiments, the substrate 72 and depending edge 74 constitute separate pieces such that the frame 70 is a two-piece frame. After applying the adhesive 68, the frame 70 is positioned over the glass sheet 52 and the depending edge 74 is lowered into contact with the adhesive 68 to attach the frame 70 to the glass sheet 52. In embodiments, the frame 70 and glass sheet 52 remain on the chuck 66 until the adhesive 68 is cured. In embodiments, the cured adhesive 68 has a thickness of 0.5 mm to 3 mm, preferably about 1 mm, between the frame 70 and the glass sheet 52.

As shown in FIG. 2C, the frame 70 has a backlight unit (BLU) 76 mounted to one side of the substrate 72 and a control board 78 mounted to an opposing side of the substrate 72. In embodiments, the control board 78 controls the flow of current to the BLU 76 and to the display modules 60. Accordingly, the control board 78 may be a printed circuit board containing a processor, a power supply, and other electronic components configured to receive and distribute electrical energy to the BLU 76 and the display modules 60.

When performed at a temperature below the softening point of the glass sheet 52, the process depicted in FIGS. 2A-2C is referred to as “cold-forming.” In a cold-forming process, the glass sheet 52 is elastically deformed to the curved configuration, and without attachment of the rigid frame 70 to hold the glass sheet 52 in the curved configuration, the glass sheet 52 would elastically revert to the planar configuration shown in FIG. 2A. In embodiments, the frame 70 is made of a metal material (e.g., stainless steel, aluminum alloy, or magnesium alloy), a plastic material (e.g., PC/ABS), or a composite material. In embodiments, cold-forming is performed at a temperature 200° C. or below, 150° C. or below, 125° C. or below, 100° C. or below, 75° C. or below, 50° C. or below, or at room temperature or below. Advantageously, cold-forming allows for application of surface treatments in a planar configuration without concern that the forming process will disrupt or damage the surface treatments (as is typically the case in hot-forming processes). Further, cold-forming processes do not introduce optical distortions typically associated with hot-forming processes.

FIG. 3 depicts a detail view of an end of the glass article 50 with the frame 70 bonded to the glass sheet 52. As shown in FIG. 3, the display module 60 is decoupled from the BLU 76 and control board 78, providing a gap (e.g., 0.5 mm to 5 mm) between the display module 60 and the BLU 76, and the display module 60 includes an electronic ribbon connector 80 that provides power and control signals to the display module 60 from the control board 78. In order to connect the electronic ribbon connector 80 to the control board 78, the electronic ribbon connector 80 has a first end 82 connected to the display module 60 and a second end 84 that is routed through a slot 86 in the substrate 72 of the frame 70. The slot 86 extends through the substrate 72 from a first side of the frame 70 to a second side of the frame 70. In embodiments, the second end 84 of the electronic ribbon connector 80 is connected to the control board 78 via a solder joint 88. In embodiments, the slot 86 is positioned adjacent to the depending edge 74 of the frame 70. In certain embodiments in which the frame 70 is a two-piece assembly, the slot 86 may be formed at the junction where the substrate 72 joins the depending edge 74.

FIG. 3 depicts a single electronic ribbon connector 80, but in other embodiments, the display module 60 may include multiple electronic ribbon connectors 80. In such embodiments, multiple slots 86 may be provided in the frame 70, or the frame 70 may include a single slot 86 sized to allow each electronic ribbon connector 80 to pass through the frame 70 for connection to the control board 78.

In conventional methods of assembling a glass article, management of the electronic ribbon connector during application of the adhesive and joining of the frame to the glass sheet slowed the assembly process. In particular, management of the electronic ribbon connector was done manually by first taping the electronic ribbon connector over the display module so that the electronic ribbon connector was not in the way of adhesive application around the perimeter of the glass sheet. Thereafter a two-piece frame with a separable substrate and depending edge was attached to the glass sheet using the adhesive, which was then allowed to cure. The substrate of the frame was removed from the depending edge to provide access to the electronic ribbon connector, and the tape holding the electronic ribbon connector to the display module was removed to free the second end of the electronic ribbon connector. The second end of the electronic ribbon connector was manually fed through a slot in the substrate of the frame, and the substrate was joined to the depending edge of the frame.

According to embodiments of the present disclosure, automated methods of routing the second end 84 of the electronic ribbon connector 80 through the slot 86 of the substrate 72 of the frame 70 are provided. Such methods can be performed without interfering with the application of the adhesive 68 and joining of the frame 70 to the glass sheet 52.

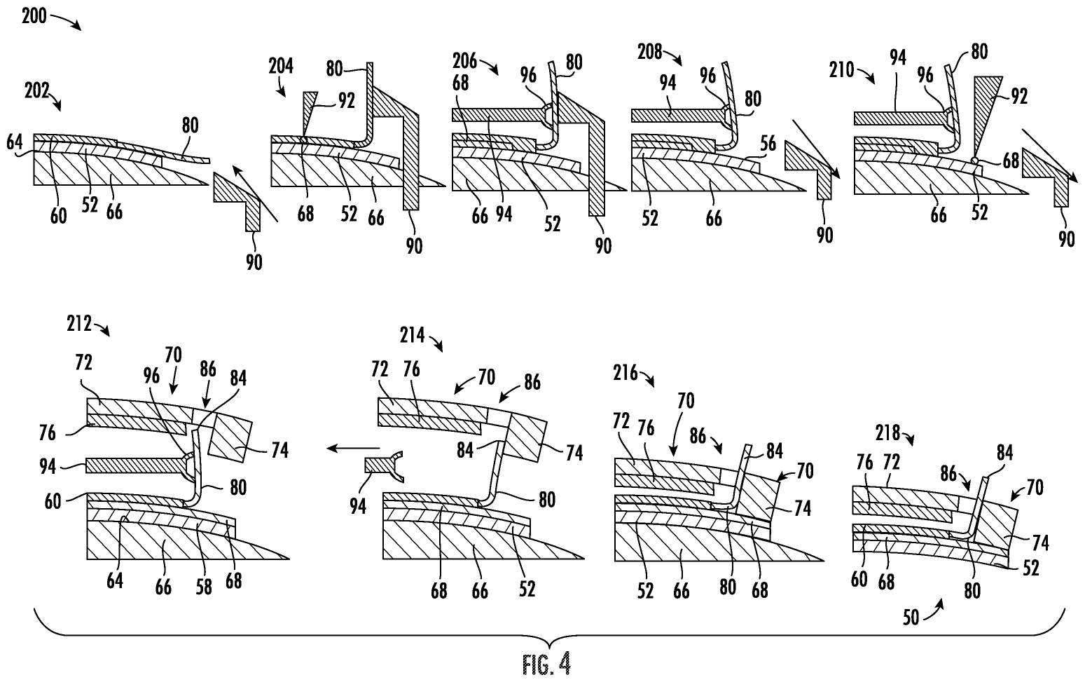

FIG. 4 depicts a first method 200 for routing the electronic ribbon connector 80 through the frame 70. In the first step 202, the glass sheet 52 with display module 60 attached thereto is positioned over the forming surface 64 of the chuck 66, and the electronic ribbon connector 80 extends over the edge of the glass sheet 52. In this initial position, the electronic ribbon connector 80 is substantially parallel to the second major surface 56 of the glass sheet 52. The first step 202 involves moving a first manipulator 90 upwardly to contact a first side, which is an underside, of the electronic ribbon connector 80. In embodiments, the first manipulator 90 may include an abutment member extending across the forming surface 64 and one or two support arms positioned on one or both sides of the forming surface 64. By raising the support arm or arms, the abutment member contacts the electronic ribbon connector 80 to lift the electronic ribbon connector 80 from its initial position.

As can be seen in the second step 204, the first manipulator 90 is moved to position the electronic ribbon connector 80 in a substantially vertical position transverse to the second major surface 56 of the glass sheet 52. During movement of the first manipulator 90, the adhesive 68 is also applied to the glass sheet 52 using an automated dispenser nozzle 92. In a third step 206, a second manipulator 94 is moved into contact with a second side of the electronic ribbon connector 80. The second manipulator 94 grips the electronic ribbon connector 80 to hold the electronic ribbon connector 80 in the vertical position. In embodiments, the second manipulator 94 includes an extension arm that terminates in a suction cup 96 that holds the electronic ribbon connector 80 by application of a suction force to the second side of the electronic ribbon connector 80. Once the second manipulator 94 grips the electronic ribbon connector 80, the first manipulator 90 is retracted in a fourth step 208. During this time, the dispenser nozzle 92 completes dispensing the adhesive 68 in a fifth step 210.

In a sixth step 212, the frame 70 with BLU 76 is positioned over and lowered toward the glass sheet 52 while the second manipulator 94 holds the electronic ribbon connector 80 in the vertical position with the second end 84 aligned with the slot 86. Once the depending edge 74 of the frame 70 has been lowered past the second end 84 of the electronic ribbon connector 80, the second manipulator 94 is withdrawn in a seventh step 214. As can be seen, the depending edge 74 of the frame 70 maintains the electronic ribbon connector 80 in the vertical position despite withdrawing the second manipulator 94. In an eighth step 216, the frame 70 is lowered such that the second end 84 of the electronic ribbon connector 80 passes through the slot 86 and such that the depending edge 74 of the frame 70 contacts the adhesive 68. The adhesive 68 is cured to join the frame 70 to the glass sheet 50, and in a ninth step 218, the completed glass article 50 is removed from the chuck 66.

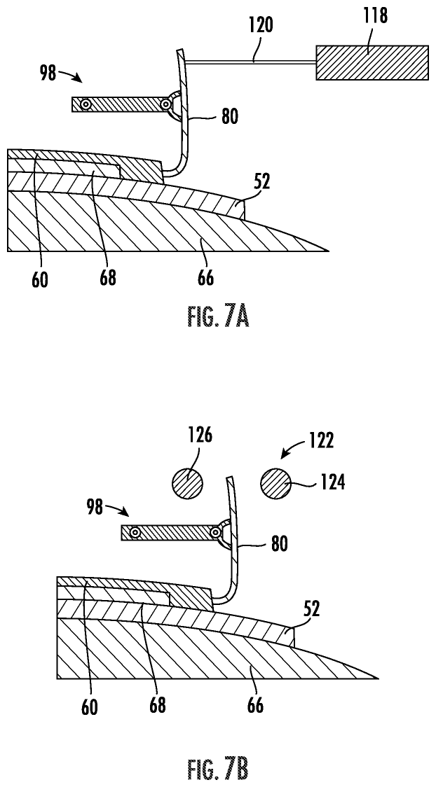

According to embodiments of the present disclosure, a system for performing the first method 200 is provided. In embodiments, the system includes the chuck 66, the first manipulator 90, and the second manipulator 94. In further embodiments, the system includes the dispenser nozzle 92 for application of the adhesive 68. In still further embodiments, the system includes a robotic arm to pick and place the frame 70 over the chuck 66. Additionally, in embodiments, the system further includes sensors (such as shown in FIGS. 7A and 7B) to detect when the electronic ribbon connector 80 is placed in the vertical position and/or to detect the position of the frame 70 in relation to the chuck 66.

FIG. 5 depicts a second method 300 for routing the electronic ribbon connector 80 through the frame 70. In the first step 302, the glass sheet 52 with display module 60 attached thereto is positioned over the forming surface 64 of the chuck 66, and the electronic ribbon connector 80 extends over the edge of the glass sheet 52. In this initial position, the electronic ribbon connector 80 is substantially parallel to the second major surface 56 of the glass sheet 52. In a second step 304, adhesive 68 is applied to the glass sheet 52 using an automated dispenser nozzle 92. In a third step 306, an articulated manipulator 98 grips the second side of the electronic ribbon connector 80. The articulated manipulator 98 includes a first joint 100 and a second joint 102 that create a two joint linkage between a first actuation arm member 104, a second actuator arm member 106, and a gripping element (such as suction cup 96). In a fourth step 308, actuation of the articulated manipulator 98 pulls the electronic ribbon connector 80 from a position substantially parallel to the second major surface 56 to the substantially vertical position transverse to the second major surface 56 of the glass sheet 52. In embodiments, the actuation of the articulated manipulator 98 is electronic, pneumatic, hydraulic, or a combination thereof. With the electronic ribbon connector 80 in the vertical position, application of the adhesive 68 using the dispenser nozzle 92 is completed in a fifth step 310.

The remainder of the method 300 is similar to the method 200 of FIG. 4. Namely, in a sixth step 312, the frame 70 with BLU 76 is positioned over and lowered toward the glass sheet 52 while the articulated manipulator 98 holds the electronic ribbon connector 80 in the vertical position with the second end 84 aligned with the slot 86. Once the depending edge 74 of the frame 70 has been lowered past the second end 84 of the electronic ribbon connector 80, the articulated manipulator 98 is withdrawn in a seventh step 314. In an eighth step 316, the frame 70 is lowered such that the second end 84 of the electronic ribbon connector 80 passes through the slot 86 and such that the depending edge 74 of the frame 70 contacts the adhesive 68. The adhesive 68 is cured to join the frame 70 to the glass sheet 50, and in a ninth step 318, the glass article 50 is removed from the chuck 66.

According to embodiments of the present disclosure, a system for performing the second method 300 is provided. In embodiments, the system includes the chuck 66 and the articulated manipulator 98. In further embodiments, the system includes the dispenser nozzle 92 for application of the adhesive 68. In still further embodiments, the system includes a robotic arm to pick and place the frame 70 over the chuck 66. Additionally, in embodiments, the system further includes sensors (such as shown in FIGS. 7A and 7B) to detect when the electronic ribbon connector 80 is placed in the vertical position and/or to detect the position of the frame 70 in relation to the chuck 66.

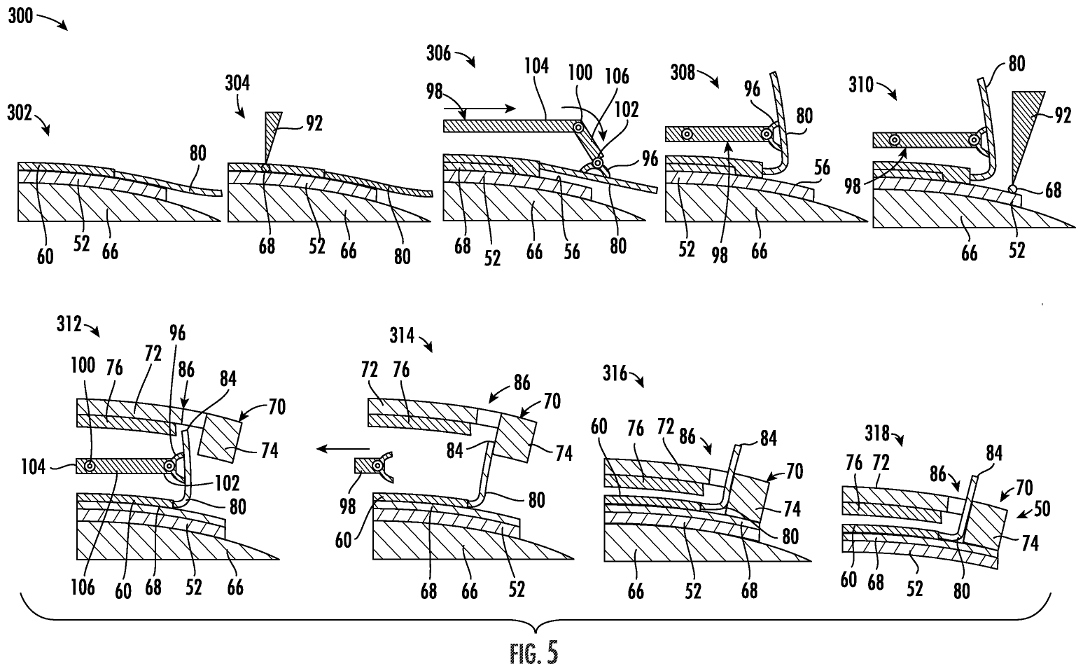

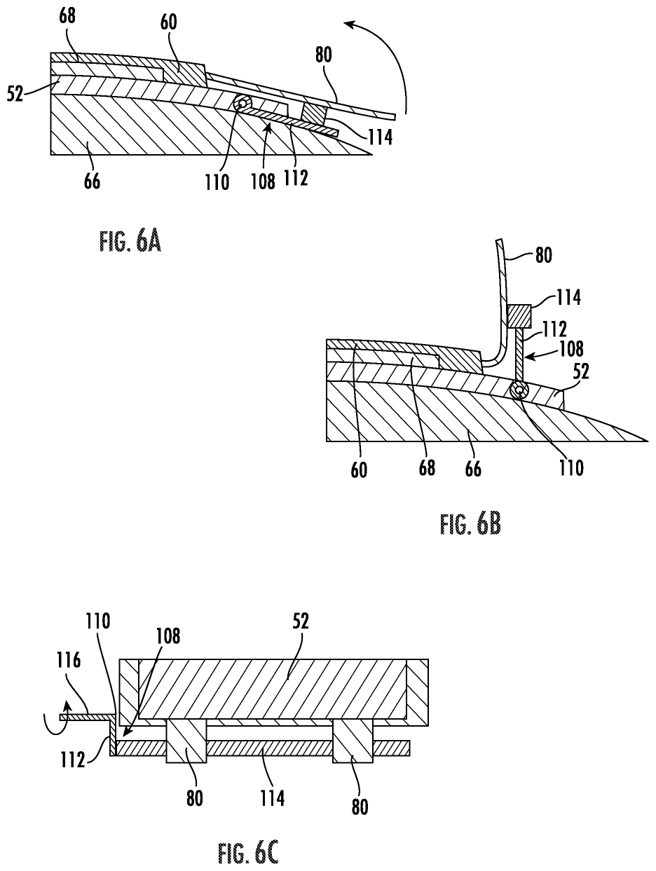

FIGS. 6A-6C depict an embodiment of a rotary manipulator 108. The rotary manipulator 108 can be used in combination with another manipulator, such as the second manipulator 94, as in the first method 200, or the rotary manipulator 108 can be used by itself as in the second method 300. As shown in FIG. 6A, the rotary manipulator 108 includes a pivot 110 positioned on the forming surface 64 adjacent to the minor surface 58 of the glass sheet 52. A first arm 112 extends from the pivot 110, and a second arm 114 extends substantially perpendicularly from the first arm 112. Upon rotation of the first arm 112 about the pivot 110, the second arm 114 lifts the electronic ribbon connector 80 to the vertical position as shown in FIG. 6B. FIG. 6C depicts a plan view of the forming surface 64. As can be seen in FIG. 6C, the first arm 112 extends from the pivot 110 past an edge of the glass sheet 52, and the second arm 114 extends from the first arm 112 along the edge of the glass sheet 52 so as to lift each electronic ribbon connector 80 along the edge of the glass sheet. FIG. 6C also depicts a spindle 116 extending from the pivot 110 perpendicularly from the first arm 112. In embodiments, the spindle 116 is driven by, e.g., a linear or rotary actuator or a motor. As with the previously discussed embodiments, adhesive 68 can be applied to the glass sheet 52 in an automated manner while also positioning the electronic ribbon connector 80 for attachment of the frame 70 at the same time.

In embodiments, a system for positioning the electronic ribbon connector 80 in the vertical position includes the chuck 66 and the rotary manipulator 108. In further embodiments, the system includes the dispenser nozzle 92 for application of the adhesive 68. In still further embodiments, the system includes a robotic arm to pick and place the frame 70 over the chuck 66. Additionally, in embodiments, the system further includes sensors (such as shown in FIGS. 7A and 7B) to detect when the electronic ribbon connector 80 is placed in the vertical position and/or to detect the position of the frame 70 in relation to the chuck 66.

FIGS. 7A and 7B depict sensors configured to facilitate automated control of the method and system for assembling the glass article. Referring to FIG. 7A, the sensor is a laser 118 having a beam 120. When the electronic ribbon connector 80 is in the vertical position, the electronic ribbon connector 80 breaks the beam 120 so that the sensor can detect that the electronic ribbon connector 80 is in the vertical position. FIG. 7B depicts another sensor in the form of a distance sensor 122 having an emitter 124 and a receiver 126 configured to detect an object using, e.g., ultrasonic waves. Other sensors can also be used to detect that the electronic ribbon connector 80 has been moved to the vertical position, such as photosensors, cameras, or a limit sensor on the manipulator. By detecting that the electronic ribbon connector 80 is in the vertical position, the system can trigger lowering of the frame 70 onto the glass sheet 52 and/or dispensing of adhesive 68 over the region of the glass sheet 52 that the electronic ribbon connector 80 was previously covering. Further, upon the depending end 74 of the frame 70 passing the second end 84 of the electronic ribbon connection, the system can trigger the withdrawal of the manipulator (e.g., articulated manipulator 98) holding the electronic ribbon connector 80 in the vertical position.

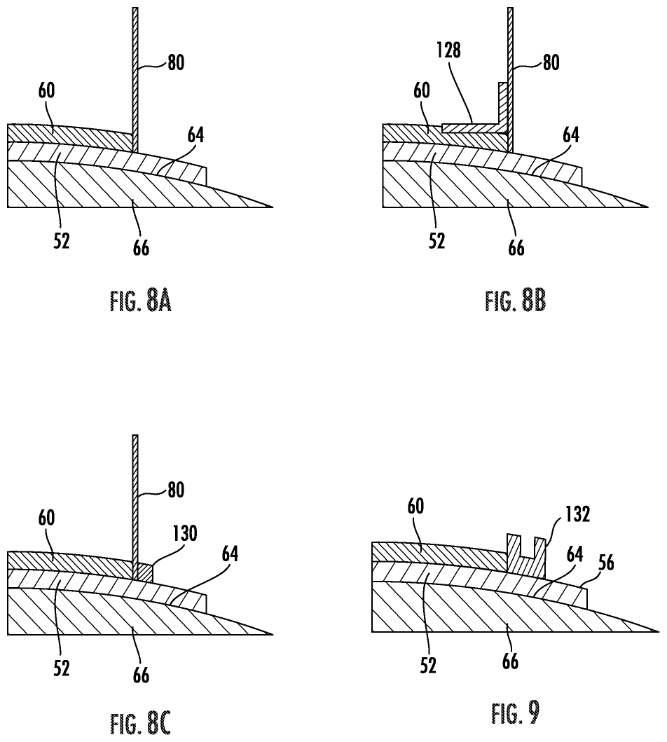

FIGS. 8A-8C depict embodiments for arranging the electronic ribbon connector 80 in a vertical position without the use of a manipulator. In the embodiment depicted in FIG. 8A, the electronic ribbon connector 80 is attached to the display module 60 in such a manner that it is oriented vertically instead of extending horizontally from the edge of the display module 60. FIG. 8B depicts the electronic ribbon connector 80 held in a vertical position by using a stiff tape 128, such as polyimide tape or aluminum tape, applied to the display module 60 and to the electronic ribbon connector 80, and FIG. 8C depicts the use of a wedge 130 attached to the second major surface 56 of the glass sheet 52 in close proximity to the edge of the display module 60 from which the electronic ribbon connector 80 extends to prop up the electronic ribbon connector 80 in the vertical position. In embodiments, the wedge 130 is made of a polymeric material. Further, in embodiments, the wedge 130 is held in place with an adhesive. In certain embodiments, the wedge 130 is removed from the second major surface of the glass sheet 52 when the frame 70 reaches a position where it is able to hold the electronic ribbon connector 80 vertically.

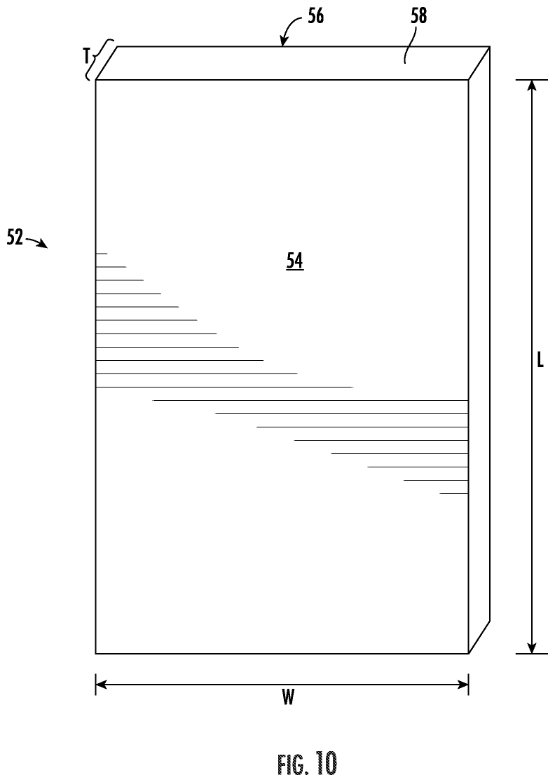

FIG. 9 depicts another solution to the issue of managing the electronic ribbon connector 80 during assembling of the glass article 50. In particular, the embodiment of FIG. 9 utilizes a display module 60 having a connector socket 132 arranged to receive an electronic ribbon connector 80 transversely, in particularly perpendicularly, to the second major surface 56 of the glass sheet 52. According to the embodiment of FIG. 9, the electronic ribbon connector 80 would have an end connected to the control board 78, and assembly of the frame 70 with the glass sheet 52 would avoid management of the electronic ribbon connector 80 until after the frame 70 was attached to the glass sheet 52. After attachment, the free end of the electronic ribbon connector 80 would simply be inserted into the connector socket 132 through the slot 86 in the frame 70.

Having described embodiments of methods and systems for assembling glass articles 50, the properties and composition of the glass sheet 52 will be described in greater detail. Referring to FIG. 10, additional structural details of glass sheet 52 of the glass article 50 are shown and described. As noted above, glass sheet 52 has a thickness T that is substantially constant and is defined as a distance between the first major surface 54 and the second major surface 56. In various embodiments, T may refer to an average thickness or a maximum thickness of the glass sheet. In addition, glass sheet 52 includes a width W defined as a first maximum dimension of one of the first or second major surfaces 54, 56 orthogonal to the thickness T, and a length L defined as a second maximum dimension of one of the first or second major surfaces 54, 56 orthogonal to both the thickness and the width. In other embodiments, W and L may be the average width and the average length of glass sheet 52, respectively.

In various embodiments, average or maximum thickness T is in the range of 0.3 mm to 2 mm. In various embodiments, width W is in a range from 5 cm to 250 cm, and length L is in a range from about 5 cm to about 1500 cm. As mentioned above, the radius of curvature of glass sheet 52 is about 50 mm or greater.

In embodiments, the glass sheet 52 may be strengthened. In one or more embodiments, glass sheet 52 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In various embodiments, glass sheet 52 may be strengthened mechanically by utilizing a mismatch of the coefficient of thermal expansion between portions of the article to create a compressive stress region and a central region exhibiting a tensile stress. In some embodiments, the glass sheet may be strengthened thermally by heating the glass to a temperature above the glass transition point and then rapidly quenching.

In various embodiments, glass sheet 52 may be chemically strengthened by ion exchange. In the ion exchange process, ions at or near the surface of the glass sheet are replaced by—or exchanged with—larger ions having the same valence or oxidation state. In those embodiments in which the glass sheet comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass sheet generate a stress.

Ion exchange processes are typically carried out by immersing a glass sheet in a molten salt bath (or two or more molten salt baths) containing the larger ions to be exchanged with the smaller ions in the glass sheet. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass sheet in a salt bath (or baths), use of multiple salt baths, additional steps such as annealing, washing, and the like, are generally determined by the composition of the glass sheet (including the structure of the article and any crystalline phases present) and the desired DOC and CS of the glass sheet that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass sheet thickness, bath temperature and glass (or monovalent ion) diffusivity. However, temperatures and immersion times different from those described above may also be used.

In one or more embodiments, the glass sheet 52 may be immersed in a molten salt bath of 100% NaNO₃, 100% KNO₃, or a combination of NaNO₃ and KNO₃ having a temperature from about 370° C. to about 480° C. In some embodiments, the glass sheet may be immersed in a molten mixed salt bath including from about 5% to about 90% KNO₃ and from about 10% to about 95% NaNO₃. In one or more embodiments, the glass sheet may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass sheet may be immersed in a molten, mixed salt bath including NaNO₃ and KNO₃ (e.g., 49%51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass sheet. The spike may result in a greater surface CS value. This spike can be achieved by a single bath or multiple baths, with the bath(s) having a single composition or mixed composition, due to the unique properties of the glass compositions used in the glass sheets described herein.

In one or more embodiments, where more than one monovalent ion is exchanged into the glass sheet, the different monovalent ions may exchange to different depths within the glass sheet (and generate different magnitudes stresses within the glass sheet at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass sheet. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn, Estonia), depending on the strengthening method and conditions. When the glass sheet is chemically strengthened by an ion exchange treatment, FSM or SCALP may be used depending on which ion is exchanged into the glass sheet. Where the stress in the glass sheet is generated by exchanging potassium ions into the glass sheet, FSM is used to measure DOC. Where the stress is generated by exchanging sodium ions into the glass sheet, SCALP is used to measure DOC. Where the stress in the glass sheet is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass sheets is measured by FSM. Central tension or CT is the maximum tensile stress and is measured by SCALP.

In one or more embodiments, the glass sheet may be strengthened to exhibit a DOC that is described as a fraction of the thickness T of the glass sheet (as described herein). For example, in one or more embodiments, the DOC may be in the range of about 0.05T to about 0.25T. In some instances, the DOC may be in the range of about 20 μm to about 300 μm. In one or more embodiments, the strengthened glass sheet 52 may have a CS (which may be found at the surface or a depth within the glass sheet) of about 200 MPa or greater, about 500 MPa or greater, or about 1050 MPa or greater. In one or more embodiments, the strengthened glass sheet may have a maximum tensile stress or central tension (CT) in the range of about 20 MPa to about 100 MPa.

Suitable glass compositions for use as glass sheet 52 include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include SiO₂ in an amount in a range from about 66 mol % to about 80 mol %. In one or more embodiments, the glass composition includes Al₂O₃ in an amount of about 3 mol % to about 15 mol %. In one or more embodiments, the glass article is described as an aluminosilicate glass article or including an aluminosilicate glass composition. In such embodiments, the glass composition or article formed therefrom includes SiO₂ and Al₂O₃ and is not a soda lime silicate glass.

In one or more embodiments, the glass composition comprises B₂O₃ in an amount in the range of about 0.01 mol % to about 5 mol %. However, in one or more embodiments, the glass composition is substantially free of B₂O₃. As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ in an amount of about 0.01 mol % to 2 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is in a range from about 8 mol % to about 20 mol %. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount in a range from about from about 8 mol % to about 20 mol %. In one or more embodiments, the glass composition includes K₂O in an amount in a range from about 0 mol % to about 4 mol %. In one or more embodiments, the glass composition may be substantially free of K₂O. In one or more embodiments, the glass composition is substantially free of Li₂O. In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In one or more embodiments, the glass composition includes CaO in an amount less than about 1 mol %. In one or more embodiments, the glass composition is substantially free of CaO. In some embodiments, the glass composition comprises MgO in an amount from about 0 mol % to about 7 mol %.

In one or more embodiments, the glass composition comprises ZrO₂ in an amount equal to or less than about 0.2 mol %. In one or more embodiments, the glass composition comprises SnO₂ in an amount equal to or less than about 0.2 mol %.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to 1 mol %. Where the glass composition includes TiO₂, TiO₂ may be present in an amount of about 5 mol % or less.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass sheet 52 may be made from any glass composition falling with any one of the exact numerical ranges discussed above.

Embodiments of the present disclosure may be more fully understood in view of the following aspects.

An aspect (1) includes method of assembling a glass article comprising a display module and a glass sheet, the glass sheet comprising a first major surface and a second major surface opposite to the first major surface, the method comprising: positioning an electronic ribbon connector in a vertical position transverse to the second major surface of the glass sheet, the electronic ribbon connector having a first end connected to the display module and a second free end, wherein the display module is attached to the second major surface of the glass sheet; applying adhesive to the second major surface of the glass sheet around the display module; arranging a frame over the second major surface of the glass sheet, the frame comprising a depending edge and a slot positioned adjacent to the depending edge; and moving the frame towards the second major surface of the glass sheet such that the second free end of the electronic ribbon connector extends through the slot and such that the depending edge of the frame contacts the adhesive.

An aspect (2) includes a method according to the aspect (1), wherein positioning comprises: lifting the second free end of the electronic ribbon connector from a first side with a first manipulator into the vertical position; and holding the electronic ribbon connector from a second side opposite to the first side with a second manipulator.

An aspect (3) includes a method according to the aspect (2), wherein the second manipulator comprises a suction cup and holding comprises applying suction to the second side of the electronic ribbon connector.

An aspect (4) includes a method according to any of aspects (2)-(3), further comprising the step of retracting the second manipulator when the depending edge of the frame passes the second free end of the electronic ribbon connector, wherein the second free end of the electronic ribbon connector abuts the depending edge during moving the frame.

An aspect (5) includes a method according to the aspect (1), wherein positioning comprises: contacting the electronic ribbon connector with an articulated manipulator, the electronic ribbon connector being in an initial position substantially parallel to the second major surface of the glass sheet; grasping the electronic ribbon connector; retracting the articulated manipulator so that the electronic ribbon connector is moved into the vertical position.

An aspect (6) includes a method according to the aspect (5), wherein the articulated manipulator comprises a suction cup and wherein grasping comprises applying suction to the electronic ribbon connector.

An aspect (7) includes a method according to any of the aspects (5)-(6), wherein the articulated manipulator comprises a two joint linkage.

An aspect (8) includes a method according to the aspect (1), wherein positioning comprising lifting the electronic ribbon connector with a rotary manipulator.

An aspect (9) includes a method according to the aspect (8), wherein the glass sheet comprises a minor surface connecting the first major surface to the second major surface, wherein the rotary manipulator comprises a pivot joint adjacent to the minor surface, a first arm extending from the pivot joint, and a second arm extending perpendicularly from the first arm, and wherein lifting comprises rotating the rotary manipulator at the pivot joint so that the second arm lifts the electronic ribbon connector in an arc to the vertical position.

An aspect (10) includes a method according to any of the aspects (1)-(9), further comprising determining that the electronic ribbon connector is the vertical position using a sensor.

An aspect (11) includes a method according to the aspect (1), wherein the sensor is selected from a group consisting of a distance sensor, a photosensor, a laser sensor, a limit sensor, and a camera.

An aspect (12) includes a method according to the aspect (1), wherein positioning comprises attaching the electronic ribbon connector to the display module in a vertical orientation.

An aspect (13) includes a method according to the aspect (1), wherein positioning comprises taping the electronic ribbon connector into the vertical position.

An aspect (14) includes a method according to the aspect (1), wherein positioning comprises propping up the electronic ribbon connector in the vertical position using a wedge attached to the second major surface of the glass sheet.

An aspect (15) includes a method according to any of the aspects (1)-(14), wherein prior to positioning, the method further comprises: adhering the display module to the second major surface of the glass sheet while the glass sheet is in a planar configuration; and bending the glass sheet over a forming surface of a chuck.

An aspect (16) includes a method according to the aspect (15), wherein bending creates a curvature in both the glass sheet and the display module.

An aspect (17) includes a method according to any of the aspects (1)-(16), wherein a back light unit is mounted to the frame and wherein, after moving the depending edge of the frame into contact with the adhesive, a gap is provided between the back light unit and the display module.

An aspect (18) includes a method according to any of the aspects (1)-(17), wherein a control board is mounted to the frame and wherein the method further comprises electrically connecting the second free end of the electronic ribbon connector to the control board.

An aspect (19) includes a system for assembling a glass article, the glass article comprising a glass sheet having a first major surface and a second major surface opposite to the first major surface, a display module that comprises an electronic ribbon connector and that is attached to the second major surface of the glass sheet, and a frame that comprises a slot and that is attached to the second major surface, the system comprising: a chuck comprising a forming surface defining a curvature, the glass sheet configured to be bent into conformity with the forming surface; a dispenser nozzle configured to apply adhesive to the second major surface of the glass sheet around the display module; and at least one manipulator configured to move the electronic ribbon connector to a vertical position such that the frame is able to be lowered into contact with the adhesive and such that an end of the electronic ribbon connector is inserted through the slot in the frame.

An aspect (20) includes a system according to the aspect (19), wherein the at least one manipulator comprises: a first manipulator configured to lift the end of the electronic ribbon connector from a first side into the vertical position; and a second manipulator configured to hold the electronic ribbon connector in the vertical position from a second side opposite to the first side.

An aspect (21) includes a system according to the aspect (20), wherein the second manipulator comprises a suction cup configured to apply suction to the second side of the electronic ribbon connector.

An aspect (22) includes a system according to the aspect (19), wherein the at least one manipulator comprises an articulated manipulator configured to grasp the electronic ribbon connector in a position substantially parallel to the second major surface of the glass sheet and to retract the electronic ribbon connector into the vertical position.

An aspect (23) includes a system according to the aspect (22), wherein the articulated manipulator comprises a suction cup configured to apply suction to the electronic ribbon connector.

An aspect (24) includes a system according to the aspect (22) or the aspect (23), wherein the articulated manipulator comprises a two joint linkage.

An aspect (25) includes a system according to the aspect (19), wherein the at least one manipulator comprises a rotary manipulator.

An aspect (26) includes a system according to the aspect (25), wherein the glass sheet comprises a minor surface connecting the first major surface to the second major surface and wherein the rotary manipulator comprises: a pivot joint disposed on the forming surface adjacent to the minor surface; a first arm extending from the pivot joint; and a second arm extending perpendicularly from the first arm; wherein the rotary manipulator is configured to be rotated at the pivot joint so that the second arm lifts the electronic ribbon connector in an arc to the vertical position.

An aspect (27) includes a system according to any of the aspects (19)-(26), further comprising a sensor configured to determine that the electronic ribbon connector has reached the vertical position.

An aspect (28) includes a system according to the aspect (27), wherein the sensor is selected from a group consisting of a distance sensor, a photo sensor, a laser sensor, a limit sensor, and a camera.

An aspect (29) includes a method of assembling a glass article comprising a display module and a glass sheet having a first major surface and a second major surface opposite to the first major surface, the display module attached to the second major surface of the glass sheet and the display module comprising a connector socket arranged transversely to the second major surface, the method comprising: applying adhesive to the second major surface of the glass sheet around the display module; arranging a frame over the second major surface of the glass sheet, the frame comprising a depending edge and a slot positioned adjacent to the depending edge; moving the frame towards the second major surface of the glass sheet such that the slot is positioned over the connector socket of the display module and the depending edge of the frame contacts the adhesive; inserting a first end of an electronic ribbon connector through the slot; and plugging the first end of the electronic ribbon connector into the connector socket.

An aspect (30) includes a glass article, comprising: a glass sheet comprising a first major surface and a second major surface, the second major surface being opposite to the first major surface; a display module attached to the second major surface of the glass sheet, the display module comprising an electronic ribbon connector; a unitary frame comprising a substrate, a depending edge, and a slot, the slot extending through the substrate and being positioned adjacent the depending edge; a backlight unit mounted on a first side of the unitary frame facing the display module; wherein the depending edge of the unitary frame is adhered to the second major surface of the glass sheet; wherein a gap is provided between the display module and the backlight unit; and wherein the electronic ribbon connector extends from the display module through the slot in the unitary frame to a second side of the unitary frame opposite to the first side.

An aspect (31) includes a glass article of the aspect (30), wherein the display module is a liquid crystal display module.

An aspect (32) includes a glass article of any of the aspects (30)-(31), wherein the gap between the display module and the backlight unit is from 0.5 mm to 5 mm.

An aspect (33) includes a glass article of any of the aspects (30)-(32), further comprising a control board on the second side of the unitary frame, wherein an end of the electronic ribbon connector is connected to the control board.

An aspect (34) includes a glass article of any of the aspects (30)-(33), wherein the glass sheet is elastically bent into a curved shape and wherein the unitary frame maintains the curved shape of the glass sheet.

An aspect (35) includes a glass article according to any of the aspects (30)-(34), wherein the unitary frame is a metal material, a plastic material, or a composite material.

An aspect (36) includes a glass article according to any of the aspects (30)-(35), wherein the first major surface, the second major surface, or both the first major surface and the second major surface comprises a surface treatment.

An aspect (37) includes a glass article according toto the aspect (36), wherein the surface treatment is selected from the group consisting of an anti-glare coating, an anti-reflective coating, a coating providing touch functionality, a decorative coating, and an easy-to-clean coating.

An aspect (38) includes a glass article according to any of the aspects (30)-(37), wherein the glass sheet comprises a thickness between the first major surface and the second major surface of 0.3 mm to 2 mm.

An aspect (39) includes a glass article according to any of the aspects (30)-(38), wherein the display module comprises a connector socket interposed between the display module and the electronic ribbon connector, wherein the connector socket is arranged transverse to the second major surface of the glass sheet, and wherein the electronic ribbon connector comprises an end plugged into the connector socket.

An aspect (40) includes a glass article according to any of the aspects (30)-(38), wherein the electronic ribbon connector extends from the display module transversely to the second major surface of the glass sheet.

An aspect (41) includes a glass article according to any of the aspects (30)-(38), further comprising tape adhered to the display module and the electronic ribbon connector, wherein the tape holds the electronic ribbon connector transverse to the second major surface.

An aspect (42) includes a glass article according to any of the aspects (30)-(38), further comprising a wedge attached to the second major surface of the glass sheet, wherein the wedge props the electronic ribbon connector in a position transverse to the second major surface of the glass sheet.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A method of assembling a glass article comprising a display module and a glass sheet, the glass sheet comprising a first major surface and a second major surface opposite to the first major surface, the method comprising:
positioning an electronic ribbon connector in a vertical position transverse to the second major surface of the glass sheet, the electronic ribbon connector having a first end connected to the display module and a second free end, wherein the display module is attached to the second major surface of the glass sheet;
applying adhesive to the second major surface of the glass sheet around the display module;
arranging a frame over the second major surface of the glass sheet, the frame comprising a depending edge and a slot positioned adjacent to the depending edge; and
moving the frame towards the second major surface of the glass sheet such that the second free end of the electronic ribbon connector extends through the slot and such that the depending edge of the frame contacts the adhesive.

2. The method of claim 1, wherein positioning comprises:
lifting the second free end of the electronic ribbon connector from a first side with a first manipulator into the vertical position; and
holding the electronic ribbon connector from a second side opposite to the first side with a second manipulator.

3. The method of claim 2, wherein the second manipulator comprises a suction cup and holding comprises applying suction to the second side of the electronic ribbon connector.

4. The method of claim 2, further comprising the step of retracting the second manipulator when the depending edge of the frame passes the second free end of the electronic ribbon connector, wherein the second free end of the electronic ribbon connector abuts the depending edge during moving the frame.

5. The method of claim 1, wherein positioning comprises:
contacting the electronic ribbon connector with an articulated manipulator, the electronic ribbon connector being in an initial position substantially parallel to the second major surface of the glass sheet;
grasping the electronic ribbon connector;
retracting the articulated manipulator so that the electronic ribbon connector is moved into the vertical position.

6. The method of claim 5, wherein the articulated manipulator comprises a suction cup and wherein grasping comprises applying suction to the electronic ribbon connector.

7. The method of claim 5, wherein the articulated manipulator comprises a two joint linkage.

8. The method of claim 1, wherein positioning comprising lifting the electronic ribbon connector with a rotary manipulator.

9. The method of claim 8, wherein the glass sheet comprises a minor surface connecting the first major surface to the second major surface, wherein the rotary manipulator comprises a pivot joint adjacent to the minor surface, a first arm extending from the pivot joint, and a second arm extending perpendicularly from the first arm, and wherein lifting comprises rotating the rotary manipulator at the pivot joint so that the second arm lifts the electronic ribbon connector in an arc to the vertical position.

10. The method according to claim 1, further comprising determining that the electronic ribbon connector is in the vertical position using a sensor, the sensor being selected from a group consisting of a distance sensor, a photosensor, a laser sensor, a limit sensor, and a camera.

11. The method of claim 1, wherein positioning comprises attaching the electronic ribbon connector to the display module in a vertical orientation.

12. The method of claim 1, wherein positioning comprises taping the electronic ribbon connector into the vertical position or propping up the electronic ribbon connector in the vertical position using a wedge attached to the second major surface of the glass sheet.

13. The method according to claim 1, wherein prior to positioning, the method further comprises:
adhering the display module to the second major surface of the glass sheet while the glass sheet is in a planar configuration; and
bending the glass sheet over a forming surface of a chuck to create a curvature in both the glass sheet and the display module.

14. The method according to claim 1, wherein a back light unit is mounted to the frame and wherein, after moving the depending edge of the frame into contact with the adhesive, a gap is provided between the back light unit and the display module.

15. A system for assembling a glass article, the glass article comprising a glass sheet having a first major surface and a second major surface opposite to the first major surface, a display module that comprises an electronic ribbon connector and that is attached to the second major surface of the glass sheet, and a frame that comprises a slot and that is attached to the second major surface, the system comprising:
a chuck comprising a forming surface defining a curvature, the glass sheet configured to be bent into conformity with the forming surface;
a dispenser nozzle configured to apply adhesive to the second major surface of the glass sheet around the display module; and
at least one manipulator configured to move the electronic ribbon connector to a vertical position such that the frame is able to be lowered into contact with the adhesive and such that an end of the electronic ribbon connector is inserted through the slot in the frame.

16. The system of claim 15, wherein the at least one manipulator comprises:
a first manipulator configured to lift the end of the electronic ribbon connector from a first side into the vertical position; and
a second manipulator configured to hold the electronic ribbon connector in the vertical position from a second side opposite to the first side, wherein the second manipulator comprises a suction cup configured to apply suction to the second side of the electronic ribbon connector.

17. (canceled)

18. The system of claim 15, wherein the at least one manipulator comprises an articulated manipulator configured to grasp the electronic ribbon connector in a position substantially parallel to the second major surface of the glass sheet and to retract the electronic ribbon connector into the vertical position wherein the articulated manipulator comprises a suction cup configured to apply suction to the electronic ribbon connector.

19. (canceled)

20. The system of claim 18, wherein the articulated manipulator comprises a two joint linkage.

21. The system of claim 15, wherein the at least one manipulator comprises a rotary manipulator, wherein the glass sheet comprises a minor surface connecting the first major surface to the second major surface and wherein the rotary manipulator comprises:
a pivot joint disposed on the forming surface adjacent to the minor surface;
a first arm extending from the pivot joint; and
a second arm extending perpendicularly from the first arm;
wherein the rotary manipulator is configured to be rotated at the pivot joint so that the second arm lifts the electronic ribbon connector in an arc to the vertical position.

22. (canceled)

23. The system of claim 15, further comprising a sensor configured to determine that the electronic ribbon connector has reached the vertical position, wherein the sensor is selected from a group consisting of a distance sensor, a photo sensor, a laser sensor, a limit sensor, and a camera.
